(19) United States
(12) Patent Application Publication
(10) Pub. No.: US 2005/0049134 A1
(43) Pub. Date: Mar. 3, 2005

(54) Cathode-ray-tube panel

(76) Inventor: Hiroshi Komori, Sakata-gun (JP)

Correspondence Address: KUBOVCIK & KUBOVCIK, SUITE 710, 900 17TH STREET NW, WASHINGTON, DC, 20006, US

(21) Appl. No.: 10/922,308

(22) Filed: Aug. 19, 2004

(30) Foreign Application Priority Data
Aug. 25, 2003 (JP) 2003-300188

(51) Int. Cl. C03C 3/078; C03C 3/085; C03C 3/095

(52) U.S. Cl. 501/72; 501/69; 501/64

(57) ABSTRACT

A cathode-ray-tube panel according to the present invention is made of a glass containing 300 to 1000 ppm of H₂O on a mass percentage basis.

### BACKGROUND OF THE INVENTION

1. Field of the Invention

The present invention relates to a cathode-ray-tube panel for use in a color television tube and a projection tube.

2. Description of the Related Art

An envelope of a cathode ray tube is constituted by a panel unit on which images are projected, a tube-shaped neck unit to which an electron gun is attached and a funnel unit which has a funnel shape that is used for connecting the panel unit and the neck unit. An electron beam, released from the electron gun, allows a fluorescent material formed on the inner face of the panel unit to emit light so that an image is projected on the panel unit. At this time, bremsstrahlung X-rays occur in the tube. When the bremsstrahlung X-rays leak outside the tube through the envelope, adverse effects are exerted to the human body; therefore, glass having a high X-ray absorbing performance is used in the envelope of this type.

In order to increase the X-ray absorbing coefficient of the glass forming the envelope, PbO is contained in the glass. In this case, however, when the glass containing PbO is used as panel glass, coloring referred to as browning is caused by electron beams and X-ray irradiation to be applied upon projecting an image, resulting in a problem that the image becomes difficult to observe.

In recent years, images are delivered by using two kinds of image sizes, that is, 4:3 and 16:9, in the image ratio; therefore, depending on the difference in the sizes, there are areas on which images are always projected and areas on which images are not projected. For this reason, in a border portion between the area on which images are always projected and the other area, there is a difference in time periods during which the electron beam is applied. This causes a large difference in the amount of browning, resulting in a problem that the image becomes difficult to observe in the border portion.

In particular, the projection tube is susceptible to a reduction in luminance due to its enlarging process for the image, and it is necessary to maintain proper luminance by increasing a voltage to be applied. For this reason, the doses of the electron beam and X-rays to be applied increase, making the projection tube more susceptible to browning.

In order to suppress browning, there have been developed glass that is allowed to contain a large amount of SrO and BaO in place of PbO, and glass in which an alkali metal oxide having a different ion radius is mixed at a predetermined ratio(see JP-A 2001-302277 and JP-A 2003-137596).

However, in recent years, the applied voltage has been further increased to obtain images with higher luminance and higher quality, and there have been strong demands for a cathode-ray-tube panel that is less susceptible to browning.

### SUMMARY OF THE INVENTION

A first object of the present invention is to provide a cathode-ray-tube panel that is less susceptible to browning.

A second object of the present invention is to provide a cathode-ray-tube panel having an X-ray-absorbing coefficient, which is suitably used as a panel for a projection tube.

The present inventors have carried out various experiments repeatedly, and found that it becomes possible to improve a browning-preventive characteristic by increasing H₂O in glass with respect to the glass to be used in a cathode-ray-tube panel; thus, the present invention has been proposed.

In other words, the cathode-ray-tube panel according to the present invention is made of glass containing 300 to 1000 ppm of H₂O on a mass percentage basis.

Moreover, in the cathode-ray-tube panel according to the present invention, the glass has an X-ray absorbing coefficient of not less than 34 cm⁻¹ at a wavelength of 0.6 angstrom.

Here, in the present invention, the amount of H₂O corresponds to a value that is obtained by measuring transmittances at a wavelength of 3846 cm⁻¹ and a wavelength of 3448 cm⁻¹ by the use of an infrared-ray spectrophotometer, and calculating based upon a formula shown below as Equation 1.

$${H}_{2} O ( ppm ) = \frac{0.187 \times log \frac{Transmittance at 3846 {cm}^{- 1} ( \% )}{Transmittance at 3448 {cm}^{- 1} ( \% )}}{Glass thickness ( mm )} \times 10000 \qquad Equation 1$$

The present invention, which exhibits a high browning-preventive characteristic, is suitably used as a cathode-ray-tube panel.

In general, browning due to an electron beam is caused by the following mechanism: an electron beam is applied to ions that constitute glass with the result that ions are reduced to form metal colloid. In other words, in the case of a cathode-ray-tube panel containing no PbO, alkali metal ions, which are easily movable ions, are shifted to a portion irradiated with the electron beam to be reduced to form metal colloid; thus, the browning occurs.

Therefore, in the cathode-ray-tube panel according to the present invention, the glass is allowed to contain H₂O at a content of not less than 300 ppm so as to suppress browning due to an electron beam. By allowing the glass to contain not less than 300 ppm of H₂O, OH⁻ ions enter gaps in a network structure of glass making alkali metal ions difficult to shift; thus, it becomes possible to suppress ions from forming colloid due to an electron beam.

Herein, when the content of H₂O is less than 300 ppm, it becomes difficult to obtain the browning-suppressing effect. In contrast, the content exceeding 1000 ppm tends to cause a reduction in the viscosity of glass and deterioration of the metal mold. The content is preferably set in a range from 320 to 900 ppm, more preferably 340 to 800 ppm.

Moreover, Examples of a method for increasing the content of H₂O may include: a method for applying a hydroxide compound to a glass material so as to be fused; a method for fusing a glass material in an atmosphere with a high partial pressure of water vapor; a method for fusing a glass material by using an oxygen burner; and a method for carrying out a bubbling process by using water vapor.

Furthermore, the cathode-ray-tube panel according to the present invention is preferably made of glass having an X-ray absorbing coefficient of not less than 34 cm⁻¹. The X-ray absorbing coefficient of less than 34 cm⁻¹ tends to cause leakage of X-rays that exert adverse effects to the human body from the tube when the glass is used for a projection tube. In order to increase the X-ray absorbing coefficient, preferably, materials such as SrO, BaO, ZnO and ZrO₂ may be added to the glass.

Here, preferable composition ranges of glass that are desirable for the cathode-ray-tube panel according to the present invention are shown as follows, without substantially containing PbO, on a mass percentage basis: 45 to 60% of SiO₂, 0 to 2% of Al₂O₃, 0 to 3% of MgO, 0 to 3% of CaO, 4 to 15% of SrO, 6 to 18% of BaO, 5 to 10% of ZnO, 0.01 to 4% of Li₂O, 0.01 to 4.5% of Na₂O, 6 to 15% of K₂O, 0 to 2% of ZrO₂, 0 to 3% of TiO₂, 0 to 3% of CeO₂ and 0 to 2% of Sb₂O₃.

The reason for the above-mentioned limitations to the glass composition in the present invention is as follows.

Although PbO is a component used for improving the X-ray absorbing performance of glass, addition of PbO tends to cause coloring referred to as browning due to electron beam and X-ray irradiation; therefore, it is preferable to substantially avoid the application of PbO to the glass of the present invention. Herein, substantially avoiding the application of PbO to the glass means that PbO is set to not more than 0.1%.

Here, SiO₂ is a network former of glass. When the content thereof becomes higher, the glass viscosity becomes higher to cause difficulty in fusing and to make the thermal expansion coefficient become too small, with the result that it becomes difficult to provide proper consistency with the funnel glass. Further, when the content is too low, the viscosity of glass becomes too low, making it difficult to carry out molding processes, and the thermal expansion coefficient becomes too high, making it difficult to provide proper consistency with the funnel glass. When the content of SiO₂ is in a range from 45 to 60%, it becomes possible to obtain glass having a thermal expansion coefficient that provides proper consistency with the funnel glass, without causing degradation in the fusing property and moldability of glass. The range is preferably set from 50 to 58%.

Further, Al₂O₃ is also a component to form a network former of glass. When the content thereof becomes higher, reaction products, referred to as leucite and potassium feldspar, are generated through reactions with refractories to cause degradation in the productivity. When the content of Al₂O₃ is in a range from 0 to 2%, it becomes possible to obtain glass that is less susceptible to generation of the reaction products with refractories. The range is preferably set from 0 to 1.8%.

MgO and CaO are components that make glass easily fused and adjust the thermal expansion coefficient and viscosity thereof. When the content of each of the components becomes higher, the glass tends to have devitrification and also to have a difficulty in molding. When the content of each of MgO and CaO is set in a range from 0 to 3%, it becomes possible to easily obtain glass that is less susceptible to devitrification. Each of the ranges is preferably set from 0 to 2%.

SrO is a component that makes glass easily fused and adjusts the thermal expansion coefficient and viscosity to improve the X-ray absorbing performance. When the content is excessive, the glass becomes more susceptible to devitrification and tends to have difficulty in molding. In contrast, the insufficient content tends to fail to provide a sufficient X-ray absorbing performance. When the content of SrO is set in a range from 4 to 15%, it becomes possible to provide glass that has a sufficient X-ray absorbing coefficient without devitrification in the glass. The range is preferably set from 5 to 14%.

In the same manner as SrO, BaO is also a component that makes glass easily fused and adjusts the thermal expansion coefficient and viscosity to improve the X-ray absorbing performance. When the content is excessive, the glass becomes more susceptible to devitrification and tends to have difficulty in molding. In contrast, the insufficient content tends to fail to provide a sufficient X-ray absorbing performance. When the content of BaO is set in a range from 6 to 18%, it becomes possible to provide glass that has a sufficient X-ray absorbing coefficient without devitrification in the glass. The range is preferably set from 7 to 16%.

In the same manner as SrO and BaO, ZnO is also a component that makes glass easily fused and adjusts the thermal expansion coefficient and viscosity to improve the X-ray absorbing performance. When the content is excessive, the glass becomes more susceptible to devitrification and tends to have difficulty in molding. In contrast, the insufficient content tends to fail to provide a sufficient X-ray absorbing performance. When the content of ZnO is set in a range from 5 to 10%, it becomes possible to provide glass that has a sufficient X-ray absorbing coefficient without devitrification in the glass. The range is preferably set from 6 to 9%.

Moreover, Li₂O is a component that is used for adjusting the thermal expansion coefficient and the viscosity. When the content becomes too high, the thermal expansion coefficient become too high, with the result that it becomes difficult to provide proper consistency with the funnel glass, and the viscosity becomes too low to cause difficulty in molding. Further, the electric insulating property tends to be lowered. In contrast, when the content becomes too low, the thermal expansion coefficient become too low, with the result that it becomes difficult to provide proper consistency with the thermal expansion coefficient of the funnel glass. When the content of Li₂O is in a range from 0.01 to 4%, it becomes possible to easily obtain glass having a thermal expansion coefficient that provides proper consistency with the funnel glass, without causing degradation in the moldability and electric insulating property. The range is preferably set from 0.01 to 3.5%.

In the same manner as Li₂O, Na₂O is also a component that is used for adjusting the thermal expansion coefficient and the viscosity. When the content becomes too high, the thermal expansion coefficient become too high, with the result that it becomes difficult to provide proper consistency with the funnel glass, and the viscosity becomes too low to cause difficulty in molding. Further, the electric insulating property tends to be lowered. In contrast, when the content becomes too low, the thermal expansion coefficient become too low, with the result that it becomes difficult to provide proper consistency with the thermal expansion coefficient of the funnel glass. When the content of Na₂O is in a range from 0.01 to 4.5%, it becomes possible to easily obtain glass having a thermal expansion coefficient that provides proper consistency with the funnel glass, without causing degradation in the moldability and electric insulating property. The range is preferably set from 0.01 to 4.0%.

In the same manner as Li₂O and Na₂O, K₂O is also a component that is used for adjusting the thermal expansion coefficient and the viscosity. When the content becomes too high, the thermal expansion coefficient become too high, with the result that it becomes difficult to provide proper consistency with the funnel glass, and the viscosity becomes too low to cause difficulty in molding. Further, the electric insulating property tends to be lowered. In contrast, when the content becomes too low, the thermal expansion coefficient become too low, with the result that it becomes difficult to provide proper consistency with the thermal expansion coefficient of the funnel glass. When the content of K₂O is in a range from 6 to 15%, it becomes possible to easily obtain glass having a thermal expansion coefficient that provides proper consistency with the funnel glass, without causing degradation in the moldability and electric insulating property. The range is preferably set from 6.2 to 14%.

Moreover, ZrO₂ is a component that adjusts the thermal expansion coefficient and viscosity, and further improves the X-ray absorbing performance. When the content is excessive, the glass becomes more susceptible to devitrification and tends to have difficulty in molding. When the content of ZrO₂ is set in a range from 0 to 2%, it becomes possible to provide glass that has a sufficient X-ray absorbing coefficient without devitrification in the glass. The range is preferably set from 0.1 to 1.8%.

TiO₂ is a component that suppresses ultraviolet-ray coloring in glass. The content of TiO₂ exceeding 3% fails to provide the corresponding effects, making the material costs higher. The range is preferably set from 0 to 2%.

CeO₂ is a component that also suppresses X-ray coloring in glass. The content of CeO₂ exceeding 3% fails to provide the corresponding effects, making the material costs higher. The range is preferably set from 0 to 2%.

Sb₂O₃ is a component that serves as a clarifier. The content of Sb₂O₃ exceeding 2% fails to provide the corresponding effects, making the material costs higher. The range is preferably set from 0 to 1.5%.

Herein, in addition to the above-mentioned components, other components may be added within a range so as not to impair glass characteristics and, for example, P₂O₅ may be added up to 0.5% as a component for suppressing devitrification. Moreover, CoO, NiO and Fe₂O₃ may be added up to 1% as colorants in the combined amount.

Next, description will be given of a manufacturing method of the cathode-ray-tube panel.

First, glass materials are adjusted and mixed to have the above-mentioned glass composition range. Next, the glass materials thus prepared are put into a continuous fusing furnace, and fusing and defoaming processes are carried out; then, the fused glass is supplied into a molding device to be press-molded, and is gradually cooled. Here, in order to adjust the content of H₂O in the glass, the following methods are used: a method for applying a hydroxide compound material to a glass material; a method for fusing a glass material in an atmosphere with a high partial pressure of water vapor; a method for fusing a glass material by using an oxygen burner; and a method for carrying out a bubbling process by using water vapor. By carrying out the above-mentioned processes, a cathode-ray-tube panel is prepared.

### DESCRIPTION OF THE PREFERRED EXAMPLES

Hereinafter, description will be given of a cathode-ray-tube panel according to the present invention in detail by way of examples.

Tables 1 and 2 show examples (samples 1 to 9) and Table 3 shows comparative examples (samples 10 to 14) of the present invention.

TABLE 1

| | Example | | | | |
|---|---|---|---|---|---|
| | 1 | 2 | 3 | 4 | 5 |
| Composition | | | | | |
| (% by mass) | | | | | |
| SiO₂ | 55.00 | 55.00 | 54.80 | 50.85 | 50.85 |
| Al₂O₃ | 0.30 | 0.30 | 0.50 | 1.70 | 1.70 |
| MgO | — | — | — | 2.00 | 2.00 |
| CaO | — | — | — | — | — |
| SrO | 8.00 | 8.00 | 8.00 | 6.00 | 6.00 |
| BaO | 13.50 | 13.50 | 13.50 | 16.00 | 16.00 |
| ZnO | 7.00 | 7.00 | 7.00 | 6.00 | 6.00 |
| Li₂O | 1.50 | 1.50 | 1.50 | 1.00 | 1.00 |
| Na₂O | 3.30 | 3.30 | 3.30 | 2.00 | 2.00 |
| K₂O | 9.00 | 9.00 | 9.00 | 13.00 | 13.00 |
| ZrO₂ | 1.40 | 1.40 | 1.40 | 0.50 | 0.50 |
| TiO₂ | 0.03 | 0.03 | 0.03 | 0.10 | 0.10 |
| CeO₂ | 0.50 | 0.50 | 0.50 | 0.80 | 0.80 |
| Sb₂O₃ | 0.20 | 0.20 | 0.20 | 0.05 | 0.05 |
| H₂O Content (ppm) | 310 | 400 | 520 | 350 | 450 |
| Amount of Browning | 7.6 | 7.2 | 6.9 | 7.1 | 6.6 |
| ΔT % | | | | | |
| Evaluation of Metal- | ◯ | ◯ | ◯ | ◯ | ◯ |
| Mold Deterioration | | | | | |
| X-ray Absorbing | 37 | 37 | 37 | 35 | 35 |
| Coefficient (0.6 Å, cm⁻¹) | | | | | |

TABLE 2

| | Example | | | |
|---|---|---|---|---|
| | 6 | 7 | 8 | 9 |
| Composition (% by mass) | | | | |
| SiO₂ | 52.85 | 54.40 | 54.40 | 54.40 |
| Al₂O₃ | 1.70 | 1.00 | 1.00 | 1.00 |
| MgO | 2.00 | — | — | — |
| CaO | — | 2.00 | 2.00 | 2.00 |
| SrO | 13.00 | 11.00 | 11.00 | 11.00 |
| BaO | 7.00 | 7.00 | 7.00 | 7.00 |
| ZnO | 6.00 | 7.50 | 7.50 | 7.50 |
| Li₂O | 1.00 | 2.00 | 2.00 | 2.00 |
| Na₂O | 2.00 | 4.00 | 4.00 | 4.00 |
| K₂O | 13.00 | 8.00 | 8.00 | 8.00 |
| ZrO₂ | 0.50 | 1.80 | 1.80 | 1.80 |
| TiO₂ | 0.10 | 0.60 | 0.60 | 0.60 |
| CeO₂ | 0.80 | 0.30 | 0.30 | 0.30 |
| Sb₂O₃ | 0.05 | 0.40 | 0.40 | 0.40 |
| H₂O Content(ppm) | 600 | 600 | 700 | 800 |
| Amount of Browning ΔT % | 6.1 | 7.8 | 7.4 | 7.1 |
| Evaluation of Metal-Mold | ◯ | ◯ | ◯ | ◯ |
| Deterioration | | | | |
| X-ray Absorbing | 35 | 39 | 39 | 39 |
| Coefficient (0.6 Å, cm⁻¹) | | | | |

TABLE 3

| | Comparative Example | | | | |
|---|---|---|---|---|---|
| | 10 | 11 | 12 | 13 | 14 |
| Composition | | | | | |
| (% by mass) | | | | | |
| SiO₂ | 54.80 | 50.85 | 54.40 | 51.40 | 54.80 |
| Al₂O₃ | 0.50 | 1.70 | 1.00 | 0.70 | 0.50 |
| MgO | — | 2.00 | — | — | — |
| CaO | — | — | 2.00 | — | — |
| SrO | 8.00 | 6.00 | 11.00 | 8.00 | 8.00 |
| BaO | 13.50 | 16.00 | 7.00 | 12.50 | 13.50 |
| ZnO | 7.00 | 6.00 | 7.50 | 7.80 | 7.00 |
| Li₂O | 1.50 | 1.00 | 2.00 | 1.40 | 1.50 |
| Na₂O | 3.30 | 2.00 | 4.00 | 3.00 | 3.30 |
| K₂O | 9.00 | 13.00 | 8.00 | 13.30 | 9.00 |
| ZrO₂ | 1.40 | 0.50 | 1.80 | 1.00 | 1.40 |
| TiO₂ | 0.03 | 0.10 | 0.60 | 0.40 | 0.03 |
| CeO₂ | 0.50 | 0.80 | 0.30 | 0.40 | 0.50 |
| Sb₂O₃ | 0.20 | 0.05 | 0.40 | 0.10 | 0.20 |
| H₂O Content(ppm) | 100 | 280 | 180 | 200 | 1050 |
| Amount of Browning | 9.2 | 9.3 | 9.9 | 9.2 | 6.5 |
| ΔT % | | | | | |
| Evaluation of | ◯ | ◯ | ◯ | ◯ | X |
| Metal-Mold | | | | | |
| Deterioration | | | | | |
| X-ray Absorbing | 37 | 35 | 39 | 38 | 37 |
| Coefficient (0.6 Å, cm⁻¹) | | | | | |

The respective samples in the tables were prepared in the following manner.

First, a material batch, prepared to have the glass composition as shown in each of the tables, was put into a platinum crucible and was fused in a fusing furnace at about 1500° C. for 4 hours. In order to increase the amount of H₂O in the glass, water-vapor bubbling was carried out in the middle of the processes so as to form homogeneous glass. Successively, the fused glass was poured into a metal mold and was pressed to be formed into a cathode-ray-tube panel of 7 inches, and this was then gradually cooled. Herein, with respect to the samples 10 to 13, the fused glass was stirred by using a platinum stirring stick without carrying out water-vapor bubbling to form homogenous glass.

With respect to the samples thus prepared, the content of H₂O, the amount of browning, the evaluation of metal-mold deterioration and the X-ray absorbing coefficient were measured, and the results are shown in the tables.

As clearly shown by the tables, each of samples 1 to 9 derived from the examples had a H₂O content in a range from 310 to 800 ppm, and the amount of browning was not more than 7.8% which was a low level, and with respect to the evaluation of metal-mold deterioration, no metal-mold deterioration was observed. Further, the X-ray absorbing coefficient was not less than 35 cm⁻¹ which was a high level.

In contrast, each of the samples 10 to 13 derived from the comparative examples had a H₂O content of not more than 280 ppm in the glass, and the amount of browning was not less than 9.2% which was a high level. With respect to the sample 14, the H₂O content in glass was 1050 ppm, and with respect to the evaluation of metal-mold deterioration, deterioration in the metal-mold was observed in the evaluation of metal-mold deterioration.

With respect to the H₂O content in glass, after both surfaces of each of the samples had been optically polished so as to have a thickness of 1 mm, light transmittances were measured by using an infrared spectrophotometer at a wavelength of 3846 cm⁻¹ and a wavelength of 3448 cm⁻¹ and the content was calculated based upon a formula shown as Equation 1.

With respect to the amount of browning, after both of the surfaces of each of the samples had been optically polished so as to have a thickness of 2 mm, light transmittance was measured at a wavelength of 400 nm, and each sample was then irradiated with an electron beam of 30 kV with 3 μA/cm² for 100 hours. Thereafter, light transmittance was again measured at a wavelength of 400 nm so that an amount of reduction in the light transmittance caused by the electron beam irradiation was found, and the resulting value was shown as ΔT %. As this reduction in the transmittance becomes greater, the browning occurs more easily, thereby indicating degradation in the browning-preventive characteristic.

With respect to the metal-mold deterioration, fused glass of each of the samples at 1000° C. was poured into a metal mold, and it was evaluated based upon the removal state from the metal mold. When no anchoring was observed between the metal mold and the glass, this state was evaluated as o that meant no deterioration, and when any anchoring was observed between the metal mold and the glass, this state was evaluated as x that meant progress of oxidation in the metal mold.

With respect to the X-ray absorbing coefficient, the absorbing coefficient at a wavelength of 0.6 angstrom was found through calculations on the basis of glass composition and density.

The cathode-ray-tube panel according to the present invention in which, in particular, the glass composition is appropriately adjusted so as to have an X-ray absorbing coefficient of not less than 34 cm⁻¹ is suitably used as a panel for a projection tube that is susceptible to browning.

1. A cathode-ray-tube panel composed of glass containing 300 to 1000 ppm of H₂O on a mass percentage basis.

2. The cathode-ray-tube panel according to claim 1, wherein the glass has an X-ray absorbing coefficient of not less than 34 cm⁻¹ at a wavelength of 0.6 angstrom.

3. The cathode-ray-tube panel according to claim 1, wherein the glass does not substantially contain PbO, but contains 45 to 60% of SiO₂, 0 to 2% of Al₂O₃, 0 to 3% of MgO, 0 to 3% of CaO, 4 to 15% of SrO, 6 to 18% of BaO, 5 to 10% of ZnO, 0.01 to 4% of Li₂O, 0.01 to 4.5% of Na₂O, 6 to 15% of K₂O, 0 to 2% of ZrO₂, 0 to 3% of TiO₂, 0 to 3% of CeO₂, and 0 to 2% of Sb₂O₃ on a mass percentage basis.

4. The cathode-ray-tube panel according to claim 2, wherein the glass does not substantially contain PbO, but contains 45 to 60% of SiO₂, 0 to 2% of Al₂O₃, 0 to 3% of MgO, 0 to 3% of CaO, 4 to 15% of SrO, 6 to 18% of BaO, 5 to 10% of ZnO, 0.01 to 4% of Li₂O, 0.01 to 4.5% of Na₂O, 6 to 15% of K₂O, 0 to 2% of ZrO₂, 0 to 3% of TiO₂, 0 to 3% of CeO₂, and 0 to 2% of Sb₂O₃ on a mass percentage basis.
